(19) United States
(12) Patent Application Publication
(10) Pub. No.: US 2005/0021581 A1
(43) Pub. Date: Jan. 27, 2005

(54) METHOD FOR ESTIMATING A PITCH ESTIMATION OF THE SPEECH SIGNALS

(76) Inventor: Pei-Ying Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,370

(22) Filed: Feb. 26, 2004

(30) Foreign Application Priority Data
Jul. 21, 2003 (TW) 092119877

(51) Int. Cl. G06F 17/15

(52) U.S. Cl. 708/426

(57) ABSTRACT

A method for calculating a pitch estimation of a speech signal that uses a voice processor. The speech signal includes a plurality of speech data and the method includes the following steps: (a) determining a pitch upper bound and a pitch lower bound of the speech signals according to speech signals and the pitch range corresponding to the speech signals stored in a database; (b) calculating a lower bound of a lag parameter and an upper bound of the lag parameter according to the pitch upper bound and the pitch lower bound of the speech signals; (c) calculating the autocorrelation values of the speech signals according to a plurality of the lag parameters between the upper bound and lower bound of the lag parameter; and (d) comparing the autocorrelation values and selecting the largest value and using the lag parameter corresponding to the largest autocorrelation value to calculate the pitch estimation of the speech signals.

### BACKGROUND OF INVENTION

1. Field of the Invention

The present invention relates to a method for estimating a pitch estimation, and more specifically, to a method for calculating a pitch estimation with the autocorrelation method.

2. Description of the Prior Art

With improvements in the field of electronic wireless communication and the increase in popularity of multimedia systems and the internet, the demand for sound signal encoding and analyzing has increased alongside. Sound telecommunication is an important application in next generation networks and also holds an important role in the multimedia telecommunication of the network.

Telecommunication is widely applied to the technique of sound signal encoding, so specification in telecommunication is quite important. There are currently some specifications in the International Telecommunication Union: PCM (64 Kpbs), G711 (64 Kpbs), G726 (ADPCM 16, 24, 32, 40 Kpbs), G728 (Low Delay CELP 16 Kpbs), G728 (Low Delay CELP 8 Kpbs). At the moment, the specifications of the cellular mobile telephone systems in North American is the VSELP encoding technique of the TIA (Telecommunication Industry Association). The specifications of the cellular mobile telephone systems in Japan and Europe are RPE-LTP encoding technique of the JDC (Japanese Digital Cellular) and GSM (Global System for Mobil Telecommunication). The current encoding technique is still at 8 Kbps. The encoding technique of the new generation is at 4.8 Kbps (LD-CELP)-2.4 Kbps (MELP,STC). For achieving such a ratio, the operation complexity is also raised. The general digital signal processor is used for finishing the immediate operation.

For matching the design, there is one or a plurality of digital signal processors in the special application design for sound compression or sound identification. The features of the DSP include a short instruction cycle, high parallelism and a plurality of special address modes to resolve general digital signal processing. The step with large amounts of operations in the voice processing is the step with the pitch estimation. The step is calculated according to equation 1.

$$R [ τ ] = {\sum }_{n = 0}^{N - 1} x [ n ] x [ n + τ ] \\ pitch period = \{ τ \vert max [ R [ τ ] ] \} \qquad equation 1$$

Equation 1 is the operation of the autocorrelation; x[n]is a sound signal comprising a plurality of voice data from x[0] to x[N−1]. Voice data x[n+τ] is a sound signal generated according to a sound signal x[n] and lags a lag parameter. Sound signal x[n+τ] is from x[τ] to x[N−1+τ]. R[τ] is a autocorrelation value corresponding to a lag parameter. R[τ] is the value of the amount of the voice data in the sound signal x[n] times the corresponding voice data in the sound signal x[n+τ].

The autocorrelation operation in the method for estimating the pitch estimation according to the prior art calculates a plurality of autocorrelation value according to each lag parameter. Then a plurality of autocorrelation values are compared and the maximum autocorrelation value of these autocorrelation values is found. The lag parameter corresponding to the maximum autocorrelation value is used for calculating the pitch estimation.

Additionally, normalizing autocorrelation method can also be used to estimate the pitch estimation. Please refer to equation 2.

$${R [ τ ]}^{2} = \frac{{[ {\sum }_{n = 0}^{N - 1} x [ n ] x [ n + τ ] ]}^{2}}{[ {\sum }_{n = 0}^{N - 1} {x [ n + τ ]}^{2} ]} \\ pitch period = \{ τ \vert max [ {Rn}^{2} [ n ] \} \qquad equation 2$$

The normalizing autocorrelation method calculates the value R[τ]² according to equation 2, i.e. the value R[τ]² is calculated according to each lag parameter τ in a plurality of lag parameters τ. The values R[τ]² are stored in a memory and compared, so the maximum R[τ]² is found. Then the lag parameter τ corresponding to the maximum R[τ]² is used for calculating the pitch estimation.

The amount of the operation of these two kinds of method for estimating pitch estimation in the digital signal processor is quite large. When the data bulk of the entry sound data is larger, the time of data processing is longer. When the sound signal cannot be operated immediately, the quality of the sound signal will be lowered.

### SUMMARY OF INVENTION

It is therefore a primary objective of the claimed invention to provide a method for calculating a pitch estimation with the autocorrelation method.

According to the claimed invention, the method calculates a pitch estimation of a sound signal with a voice processor. The sound signal comprises a plurality of sound data. The method comprises the following steps: (a) determining a pitch upper bound value and a pitch lower bound value according to the signal and corresponding pitch ranges in a database; (b) calculating a lag parameter upper bound value and a lag parameter lower bound value according to the pitch upper bound value and the pitch lower bound value determined in step (a); (c) using the voice processor to generate a plurality of autocorrelation values according to a plurality of pointer values between the lag parameter lower bound value and the lag parameter upper bound value; and (d) comparing the plurality of autocorrelation values to find the maximum of the plurality of autocorrelation values and calculating the pitch estimation of the sound signal according to the lag parameter corresponding to the maximum autocorrelation values.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a voice processing device according to the invention.

FIG. 2 is a flowchart of a method for estimating a pitch estimation in the first embodiment according to the invention.

FIG. 3 is a flowchart of a method for estimating a pitch estimation in the second embodiment according to the invention.

### DETAILED DESCRIPTION

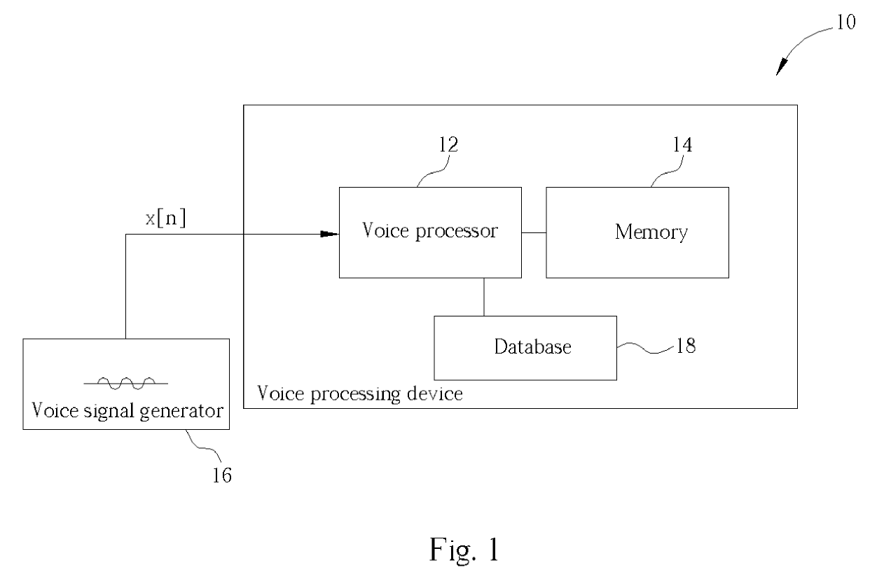

Please refer to FIG. 1. FIG. 1 is a block diagram of a voice processing device 10 according to the invention. A sound signal is input in a voice processing device 10. The voice processing device 10 comprises a voice processor 12 for processing sound signal x[n], a memory 14 for storing a plurality of lag parameters and autocorrelation values R[τ] calculated by the voice processing device 10 and a database 18 for storing the sound signal x[n] and corresponding pitch range. The sound signal x[n] is generated by a sound signal generator 16 and input in the voice processing device 10.

The database 18 is used for storing different sound signals and corresponding pitch ranges. When the voice processing device 10 receives a sound signal x[n], the voice processor 12 compares the sound signal x[n] and the data in the database 18 to analyze which kind of sound signal the sound signal x[n] is and calculate the pitch range of this kind of sound signal to determined the pitch upper bound value
Pupper
   and the pitch lower bound value
Plower
   .

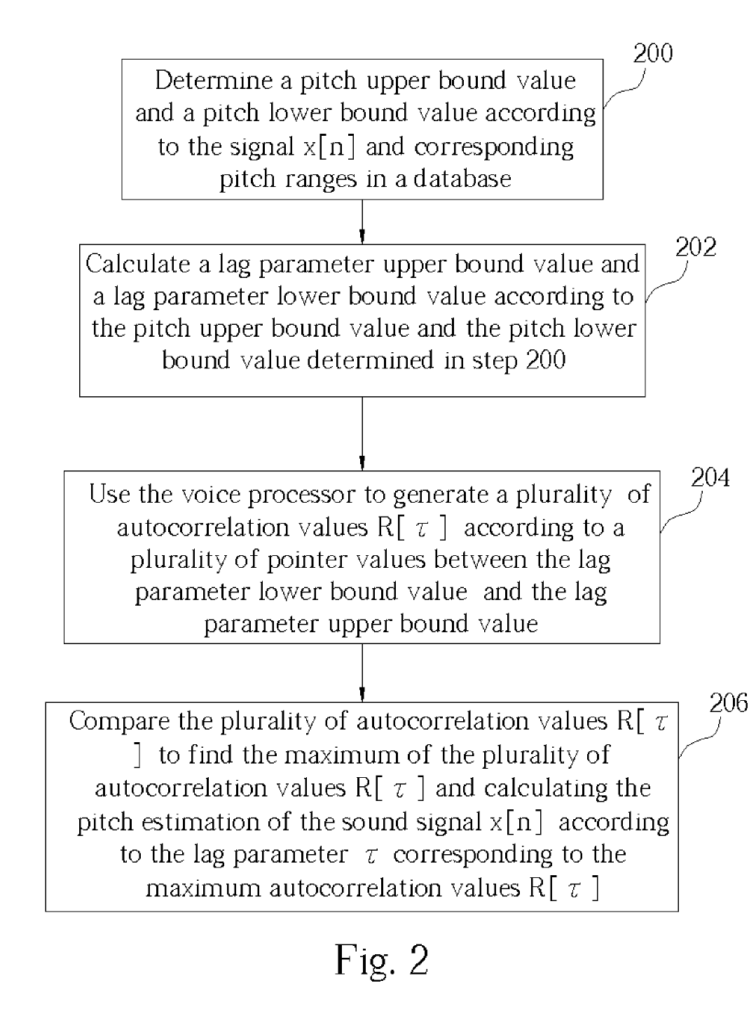

Please refer to FIG. 2. FIG. 2 is a flowchart of the method for estimating a pitch estimation in the first embodiment according to the invention. The method for estimating the pitch estimation in the invention is operated according to equation 3. The method comprises the following steps:

$$R [ k ] = {\sum }_{n}^{} x [ n ] x [ n + k ] \\ wherein n = i \times {Δ}_{n} i = 1 , 2 , 3 , … , ceil ( \frac{{W}_{n}}{{Δ}_{n}} ) \qquad equation 3$$

Step 200: determining a pitch upper bound value
   Pupper
and a pitch lower bound value
   Plower
according to the signal x[n] and corresponding pitch ranges in a database 18;
Step 202: calculating a lag parameter upper bound value and a lag parameter lower bound value according to the pitch upper bound value
   Plower
and the pitch lower bound value determined in step 200;
Step 204: using the voice processor 12 to generate a plurality of autocorrelation values R[τ] according to a plurality of pointer values between the lag parameter lower bound value
   Pupper
and the lag parameter upper bound value
   Plower
; and
Step 206: comparing the plurality of autocorrelation values R[τ] to find the maximum of the plurality of autocorrelation values R[τ] and calculating the pitch estimation of the sound signal x[n] according to the lag parameter t corresponding to the maximum autocorrelation values R[τ].

In step 200, the voice processor 12 determines a pitch upper bound value
Pupper
   and a pitch lower bound value
Plower
   according to signal x[n] and the corresponding pitch ranges in a database 18;
In step 202, the voice processor 12 calculates a lag parameter upper bound value
Wn
   and a lag parameter lower bound value
Δn
   according to the pitch upper bound value
Pupper
   and the pitch lower bound value
Plower
   determined in step 200. The lag parameter upper bound value
Wn
   is that the sampling frequency divided by the pitch lower bound value
Plower
   and the lag parameter lower bound value
Δn
   is the sampling frequency divided by the pitch upper bound value
Pupper
   .

In the step 204, the voice processor 12 is used for generating a plurality of autocorrelation values R[τ] according to a plurality of pointer values between the lag parameter lower bound value
Δn
   and the lag parameter upper bound value
Wn
   . An increment value is set and equal to the lag parameter lower bound value
Δn
   , the increment value being equal to the difference between two neighboring pointer values. The first pointer value is equal to the lag parameter lower bound value
Δn
   ; the second pointer value is equal to two times the lag parameter lower bound value 2
Δn
   and other pointer values is the multiple of the lag parameter lower bound value. The maximum pointer value is the lag parameter value
Wn
   .

In step 206, the voice processor device 10 compares the autocorrelation values to find the maximum of the autocorrelation values R[τ] and calculates the pitch estimation according to the corresponding lag parameter τ and the equation 4.

$$pitch = \frac{{F}_{5}}{{k}_{max}} \qquad equation 4$$

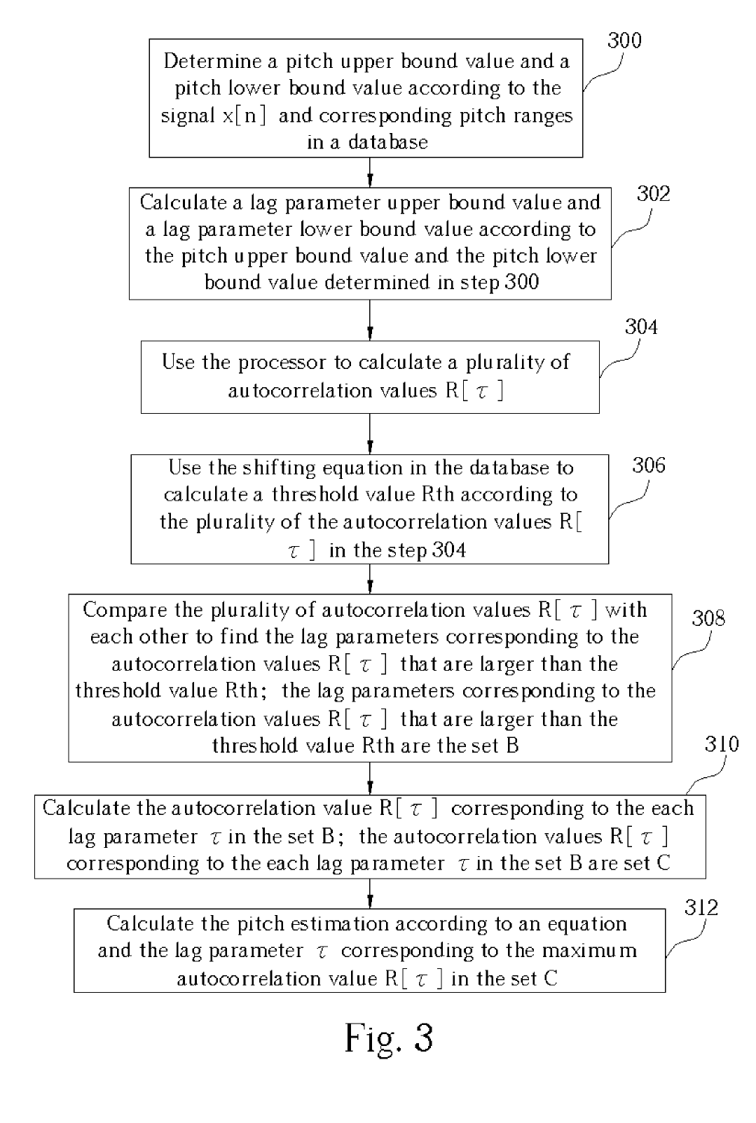

Please refer to FIG. 3. FIG. 3 is a flowchart of the method for estimating a pitch estimation in the second embodiment according to the invention.
Step 300: determining a pitch upper bound value
   Pupper
and a pitch lower bound value
   Plower
according to signal x[n] and corresponding pitch ranges in a database 18;
Step 302: calculating a lag parameter upper bound value
   Pupper
and a lag parameter lower bound value according to the pitch upper bound value
   Plower
and the pitch lower bound value determined in step 200;
Step 304: using the processor 12 to calculate a plurality of autocorrelation values R[τ];
Step 306: using the shifting equation in the database 18 to calculate a threshold value Rₜₕ according to the plurality of the autocorrelation values R[τ] in the step 304;
Step 308: comparing the plurality of autocorrelation values R[τ] with each other to find the lag parameters corresponding to the autocorrelation values R[τ] that are larger than the threshold value Rₜₕ; the lag parameters corresponding to the autocorrelation values R[τ] that are larger than the threshold value Rₜₕ are the set B;
Step 310: calculating the autocorrelation value R[τ] corresponding to the each lag parameter τ in the set B; the autocorrelation values R[τ] corresponding to the each lag parameter τ in the set B are the set C; and
Step 312: Calculating the pitch estimation according to equation 4 and the lag parameter τ corresponding to the maximum autocorrelation value R[τ] in the set C.

In step 300, the voice processor 12 determines a pitch upper bound value
Pupper
   and a pitch lower bound value
Plower
   according to the signal x[n] and corresponding pitch ranges in a database 18;
In step 302, the voice processor 12 calculates a lag parameter upper bound value
Wn
   and a lag parameter lower bound value
Δn
   according to the pitch upper bound value
Pupper
   and the pitch lower bound value
Plower
   determined in step 200. The lag parameter upper bound value
Wn
   is the sampling frequency divided by the pitch lower bound value
Plower
   and the lag parameter lower bound value
Δn
   is the sampling frequency divided by the pitch upper bound value
Pupper
   .

In step 304, the voice processor 12 is used for generating a plurality of autocorrelation values R[τ] according to a plurality of pointer values between the lag parameter lower bound value
Δn
   , the lag parameter upper bound value
Wn
   and equation 3.

In steps 306 and 308, the shifting equation in the database 18 is used for calculating a threshold value Rₜₕ according to the plurality of the autocorrelation values R[τ] in the step 304. The plurality of autocorrelation values R[τ] are compared with each other to find the lag parameters corresponding to the autocorrelation values R[τ] that are larger than the threshold value Rₜₕ. The lag parameters corresponding to the autocorrelation values R[τ] that are larger than the threshold value Rₜₕ is set B. An increment value is set and equal to the lag parameter lower bound value
Δn
   , the increment value being equal to the difference between two neighboring pointer values. The first pointer values is equal to the lag parameter lower bound value
Δn
   ; the second pointer value is equal to two times the lag parameter lower bound value 2
Δn
   and other pointer values is the multiple of the lag parameter lower bound value. The Maximum of the pointer value is the lag parameter value
Wn
   .

In steps 310 and 312, each autocorrelation value R[τ] corresponding to the each lag parameter τ in the set B is calculated according to the lag parameter τ in the set B and the equation 3. the autocorrelation values R[τ] corresponding to the each lag parameter τ in the set B are set C. Then the pitch estimation is calculated according to the equation 4 and the lag parameter τ corresponding to the maximum autocorrelation value R[τ] in the set C.

Compared to the prior art, the pitch range of the sound signal in the invention is determined according to the database 18. The lag parameter upper bound value and the lag parameter lower bound value are calculated according to the pitch upper bound value and the pitch lower bound value. After that, the pointer values between lag parameter upper bound value and the lag parameter lower bound value are chosen for calculating the pitch estimation. The method for calculating the pitch estimation in the invention is different from the method for calculating the pitch estimation according to the prior art that uses all the parameters to calculate the autocorrelation values. The method for calculating the pitch estimation in the invention reduces the amount of operations and ensures that the pitch estimation is exactly determined.

Those skilled in the art will readily observe that numerous modifications and alterations of the method and device may be made while retaining the teachings of the invention. Accordingly, the above disclosure should be constructed as limited only by the metes and bounds of the appended claims.

1. A method for calculating a pitch estimation of a sound signal with a voice processor, the sound signal comprising a plurality of sound data, the method comprising the following steps:
(a) determining a pitch upper bound value and a pitch lower bound value according to the signal and corresponding pitch ranges in a database;
(b) calculating a lag parameter upper bound value and a lag parameter lower bound value according to the pitch upper bound value and the pitch lower bound value determined in step (a);
(c) using the voice processor to generate a plurality of autocorrelation values according to a plurality of pointer values between the lag parameter lower bound value and the lag parameter upper bound value;
(d) comparing the plurality of autocorrelation values to find the maximum of the plurality of autocorrelation values and calculating the pitch estimation of the sound signal according to the lag parameter corresponding to the maximum autocorrelation values.

2. The method of claim 1 wherein the step (c) further comprises setting an increment value equal to the lag parameter lower bound value, the increment value being equal to the difference between two neighboring pointer values.

3. The method of the claim 1 wherein the method further comprises the following steps:
providing a threshold value;
comparing the plurality of autocorrelation values and the threshold value to find the maximum autocorrelation value in the plurality of autocorrelation values and calculating the pitch estimation of the sound signal according to the lag parameter corresponding to the maximum autocorrelation.

4. A sound processing device for implementing the method of claim 1.
